(19) United States
(12) Patent Application Publication
(10) Pub. No.: US 2022/0152469 A1
(43) Pub. Date: May 19, 2022

(54) SYSTEM, DEVICE, AND METHOD FOR POSITIONING

(71) Applicant: Teambit Pty Ltd, Northcote (AU)

(72) Inventors: Brendan Patrick Murray, Northcote (AU); Alexander James Stumpf, Northcote (AU); Michael Evert Scicluna, Northcote (AU)

(73) Assignee: Teambit Pty Ltd, Northcote (AU)

(21) Appl. No.: 17/666,451

(22) Filed: Feb. 7, 2022

Related U.S. Application Data
(63) Continuation of application No. PCT/AU2020/050820, filed on Aug. 7, 2020.

(30) Foreign Application Priority Data
Aug. 9, 2019 (AU) 2019902859

(51) Int. Cl. A63B 71/06; A63B 24/00; G01S 1/08; G01S 5/00; H04W 4/021

(52) U.S. Cl. CPC A63B 71/0622; A63B 24/0021; G01S 1/08; G01S 5/0036; H04W 4/021; A63B 2024/0025; G01S 2205/08; A63B 2214/00; A63B 2220/89; A63B 2024/0037; A63B 2071/0625; A63B 2071/0655; G01S 2201/05; A63B 2220/836

(57) ABSTRACT

A method for positional analysis, comprising the steps of: receiving, from a user device, location information indicating a location of the user device; identifying a location of at least one reference target; determining at least one intended location of the user device by applying a structure model to the location of the, or each, reference target; determining a difference between the, or each, intended location and the location of the user device; determining a first result indicating whether the difference meets a threshold distance of a predefined threshold rule; determining a second result indicating whether the predefined threshold rule is satisfied based at least in part on the first result; and in response, communicating an instruction to the user device indicating that the predefined threshold rule is satisfied, and associated system and device.

### CROSS REFERENCE TO RELATED APPLICATION

This application is a continuation of Patent Cooperation Treaty Application No. PCT/AU2020/050820, filed on Aug. 7, 2020, which claims the benefit of earlier filed Australian Application No. 201990259, filed on Aug. 9, 2019. The disclosures of these prior applications are considered part of the disclosure of this application and are hereby incorporated by reference in their entireties.

### FIELD

The invention generally relates to a system and method for assisting in training.

### BACKGROUND

A current focus for coaches in various sporting codes, such as the Australian Football League (AFL), is teaching “team structure” and a player's role within that team structure. However, players struggle to learn correct proximity to players, ball, and landmarks and, as a result, players fail to implement team structure during play (and when fatigued).

In the AFL, players are coached to be positioned in a particular formation at different times during a game. In football talk, this is referred to generally as team structure. Team structure refers to the positions that the head coach (or club strategist) wants their players to stand in dependent upon where the ball is on the field. And, as the AFL field is up to 20,000 square metres, the ball can be in approximately 70 “tolerance zones” that require 70 different positions that a player must learn and adopt. However, these 70 different positions become perhaps 100 different positions given that an AFL team requires its players to adopt different roles throughout a 120+ minute game period.

It is inherently difficult to teach structure, shape, and role when a player needs to position themselves in a particular proximity to another player but the required position changes, depending on ball movement. It is also difficult to teach a player to pay attention to ball position and player position in proximity to each player in the moment of play and while they are fatigued.

Although recording locations of players during training or sporting events is known, there is a desire to provide feedback to players.

### SUMMARY

In an embodiment, a method for positional analysis is provided, comprising: receiving, from a user device, location information indicating a location of the user device; identifying a location of at least one reference target; determining at least one intended location of the user device by applying a structure model to the location of the, or each, reference target; determining a difference between the, or each, intended location and the location of the user device; determining a first result indicating whether the difference meets a threshold distance of a predefined threshold rule; determining a second result indicating whether the predefined threshold rule is satisfied based at least in part on the first result; and in response, communicating an instruction to the user device indicating that the predefined threshold rule is satisfied.

The user device may be configured to be worn by a user, such as a player being coached.

Optionally, the method further comprises the steps of: determining that the intended location is outside of a boundary; and applying a correction to the intended location, wherein the corrected intended location is within the boundary or the corrected intended location is not within a threshold distance of the boundary. The intended location may be determined according to a team coordinate system and the method may further comprises the step of transforming the intended location to a field coordinate system in order to compare the intended location to the location of the user device. The team coordinate system may be moveable with respect to one axis of the field coordinate system with fixed orientation. In an alternative, the team coordinate system may be moveable with respect to two axes of the field coordinate system with fixed orientation. In another alternative, the team coordinate system may be moveable with respect to two axes of the field coordinate system with variable orientation. In the latter alternative, the method may include the step of: calculating a transformation between the team coordinate system and the field coordinate system based on, at least in part, a current position of at least one reference target with respect to at least one stationary target in the field coordinate system. The transformation may include a scaling factor determined in accordance with the current position of the at least one reference target with respect to the at least one stationary target in the field coordinate system. The scaling factors for each of two axes of the field coordinate system may be determined. The field coordinate system may be related to the boundary by a scaling factor.

In an embodiment, the method is implemented by a server. The server may communicate with the user device via a base station. The method may include the step of: receiving, at the server, a user input corresponding to a selection of the structure model for determining the intended location. The structure model may be selected from a group of selectable structure models and/or the structure may be created by the user and then selected.

Optionally, the location information is received from the user device intermittently or periodically.

Optionally, a reference target is a movable target such as a ball. The method may further comprise the step of receiving location information of the movable target from a locator device affixed to the movable target. Alternatively, the method may further comprise the steps of: receiving a signal strength measurement from each of one or more user devices, wherein the signal strength measurement is a measurement based on a received beacon signal received by the user device(s); associating one of the user devices with the reference target based on the signal strength measurements; and determining the reference target location to be the current location of the associated user device. Optionally, at least one reference target is a stationary target.

The threshold rule may correspond to the difference being within a predefined value. The threshold rule may alternatively correspond to the difference being outside of a predefined value.

In an embodiment, the user device is configured to vibrate and/or emit an audible signal in response to receiving the instruction.

The method may further comprise the step of: defining the location of a boundary by recording the location of a user device as it is moved around the boundary.

Optionally, the structure model is configured to calculate the intended location relative to the location of at least one reference target.

According to an embodiment, one intended location is determined. According to another embodiment, the method further comprises the steps of: determining a player proximity rule defining an intended number of user devices for the intended location; upon determining the first result indicating the user device is at one of a plurality of intended locations, determining a number of other user devices at the one determined intended location; and determining a third result indicating that the player proximity rule is satisfied according to the number of other user devices at the intended location. The player proximity rule may define that no other user device is to be located at the intended location.

In an embodiment, a method for positional analysis is provided, comprising: receiving, from a plurality of user devices, location information indicating a location of each user device; identifying a location of at least one reference target; determining at least one intended location of each user device by applying a structure model to the location of the, or each, reference target; for each user device, determining a difference between the, or each, intended location and the location of the user device; for each user device, determining a result indicating whether the difference meets a threshold distance of a predefined threshold rule; for each user device, determining a second result indicating whether the predefined threshold rule is satisfied based at least in part on the first result; and for each user device meeting the threshold rule, communicating an instruction to the user device indicating that the predefined threshold rule is satisfied.

In an embodiment, a system for positional analysis is provided, comprising: one or more user devices, each comprising a stimulus module configured to, when activated, provide a recognisable stimulus to a wearer of the user device; and a server, wherein the one or more user devices are each configured for two-way communication with the server, wherein the server is configured to: receive location information indicating a location of a particular user device; identify a location of at least one reference target; determine at least one intended location of the particular user device by applying a structure model to the location of the, or each, reference target; determine a difference between the, or each, intended location and the location of the particular user device; determine a first result indicating whether the difference meets a threshold distance of a predefined threshold rule; determine a second result indicating whether the predefined threshold rule is satisfied based at least in part on the first result; and in response, communicating an instruction to the particular user device indicating that the predefined threshold rule is satisfied, and wherein the, or each, user device is configured to: determine a current location of the user device; communicate location information indicating its location to the server; in response to receiving an instruction to activate a stimulus from the server, activate the stimulus module.

Each user device may be configured to be worn by a user.

Optionally, the server is further configured to: determine that the intended location is outside of a boundary; and apply a correction to the intended location, wherein the corrected intended location is within the boundary or the corrected intended location is not within a threshold distance of the boundary. The intended location may be determined according to a team coordinate system and the server may be further configured to: transform the intended location to a field coordinate system in order to compare the intended location to the location of the user device. The team coordinate system may be moveable with respect to one axis of the field coordinate system with fixed orientation. In an alternative, the team coordinate system may be moveable with respect to two axes of the field coordinate system with fixed orientation. In another alternative, the team coordinate system may be moveable with respect to two axes of the field coordinate system with variable orientation. In the latter alternative, the server may be further configured to: calculate a transformation between the team coordinate system and the field coordinate system based on, at least in part, a current position of at least one reference target with respect to at least one stationary target in the field coordinate system. The transformation may include a scaling factor determined by the server in accordance with the current position of the at least one reference target with respect to the at least one stationary target in the field coordinate system. Scaling factors for each of two axes of the field coordinate system may be determined. The field coordinate system may be related to the boundary by a scaling factor.

The system may further comprise a base station, and the server may communicate with the user devices via a base station. The server may be further configured to: receive a user input corresponding to a selection of the structure model for determining the intended location. The structure model may be selected from a group of selectable structure models stored in a memory of the server and/or the structure model may be created by the user and then selected.

Optionally, each user device communicates the location information intermittently or periodically.

Optionally, a reference target is a movable target such as a ball. The system may further comprise a locator device affixed to the movable target and configured to communicate location information indicating its position to the server, such that the server identifies the location of the movable target based on the received location information. Alternatively, the system may further comprise a beacon device affixed to the movable target configured to intermittently or periodically emit a beacon signal, and each user device may be further configured to, upon detecting the beacon signal, determine a signal strength of the detected beacon signal and to communicate the signal strength to the server, and the server may be further configured to: receive the signal strength measurement(s) from one or more of the user devices; associate one of the user devices with the reference target based on the signal strength measurements; and determine the reference target location to be the current location of the associated user device. Optionally, at least one reference target is a stationary target.

The threshold rule may correspond to the difference being within a predefined value. The threshold rule may alternatively correspond to the difference being outside of a predefined value.

In an embodiment, one intended location is determined for each user device. In another embodiment, the server is further configured to: determine a player proximity rule defining an intended number of user devices for the intended location; upon determining the first result indicating the user device is at one of a plurality of intended locations, determine a number of other user devices at the one determined intended location; and determine a third result indicating that the player proximity rule is satisfied according to the number of other user devices at the intended location. The player proximity rule may define that no other user device is to be located at the intended location.

In an embodiment, a system for positional analysis is provided, comprising: one or more user devices, each comprising a stimulus module configured to, when activated, provide a recognisable stimulus to a wearer of the user device; and a server, wherein the one or more user devices are each configured for two-way communication with the server, wherein the server is configured to: receive location information indicating a location of at least one of the one or more user devices; identify a location of at least one reference target; determine at least one intended location of the at least one user device by applying a structure model to the location of the, or each, reference target; determine a difference between the, or each, intended location and the location of the, or each of the at least one, user device; determine a first result, for each of the at least one user device, indicating whether the difference meets a threshold distance of a predefined threshold rule; determine a second result indicating whether the predefined threshold rule is satisfied based at least in part on the first result; and in response, for each instance of the predefined threshold rule being satisfied, communicate an instruction to the associated user device indicating that the difference meets the predefined threshold rule, and wherein the, or each, user device is configured to: determine a current location of the user device; communicate location information indicating its location to the server; in response to receiving an instruction from the server, activate its stimulus module.

Embodiments can be implemented by a suitably configured server. For example, methods described in relation to certain embodiments can be implemented by a suitable computer program comprising code configured to cause a processor to implement the method(s) when said code is executed by the processor.

As used herein, the word “comprise” or variations such as “comprises” or “comprising” is used in an inclusive sense, i.e. to specify the presence of the stated features but not to preclude the presence or addition of further features in various embodiments of the invention.

### BRIEF DESCRIPTION OF THE DRAWINGS

In order that the invention may be more clearly understood, embodiments will now be described, by way of example, with reference to the accompanying drawing, in which:

FIG. 1 shows an arrangement of features of the system;

FIG. 2 shows an embodiment of a user device;

FIG. 3 shows an embodiment of a base station and server;

FIG. 4 shows a method for controlling a user device;

FIG. 5 shows a reference target with respect to a bounded area;

FIG. 6 shows a method for determining the location of a reference target;

FIG. 7A shows a field coordinate system according to an embodiment;

FIG. 7B shows a team coordinate system according to an embodiment;

FIG. 8 shows a method for defining the field coordinate system;

FIGS. 9A to 9C show different relationships between a field coordinate system and a team coordinate system;

FIG. 10 shows an overview of the application of a structure model, according to an embodiment;

FIG. 11 shows an example of zones used with the coordinate systems;

FIG. 12 shows an account taking of a border, according to an embodiment;

FIG. 13 shows correcting an intended location which is outside of a border, according to an embodiment;

FIG. 14 shows an example of polar coordinates used in an embodiment;

FIG. 15 shows an embodiment including a control device; and

FIG. 16 relates to an embodiment wherein a user device can be associated with a plurality of intended locations.

### DESCRIPTION OF EMBODIMENTS

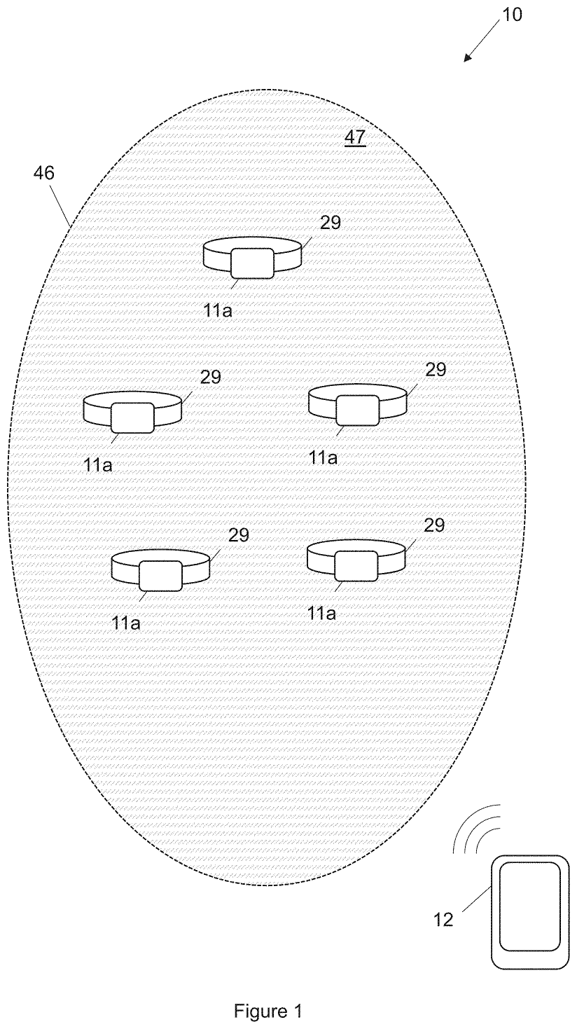

FIG. 1 shows an illustrative arrangement of a system for analysis 10, according to an embodiment. The system 10 includes one or more user devices 11 (the figure shows five user devices 11a-11e), a server 12, and a base station 13.

A numerical reference to the figures is used herein to refer to a general feature—for example, user devices 11. However, where necessary to distinguish between different instances of a general feature, a lowercase letter suffix is provided—for example, compare user device 11a and user device 11b.

In use, the user devices 11 are located normally within a bounded area 47—that is, the physical location of the user devices 11 is relevant, and typically, with respect to the bounded area 47. The bounded area 47 is typically defined by an area within a boundary 46. For the purposes of this disclosure, several assumptions are made for ease of illustration. It is assumed that the system 10 is utilised within the context of sports coaching and therefore, each user device 11 is associated with a particular coached player 48. Generally, reference to a “player location” should be understood to be the same as reference to a location of a user device. It is also assumed that the coaching occurs in relation to a particular sport and in an area associated with the sport—that is, the term “sports field 47” is used as a metonym for “bounded area 47”. Thus, a location of a player 48 can be the player's location within (or, where applicable, within or outside) the sports field 47. Reference is made herein to several different sporting codes to assist with illustration—reference to these specific sports should not be considered limitation. Examples include Australian Rules Football and Association Football (“soccer”).

Generally, each user device 11 is configured to be worn (or otherwise attached) to a player 48—as shown in FIG. 1, each user device 11 is located with a player 48. Each user device 11 is affixed to a strap 29—for example, the user devices 11 are configured to be worn around an ankle of a player 48 using strap 29.

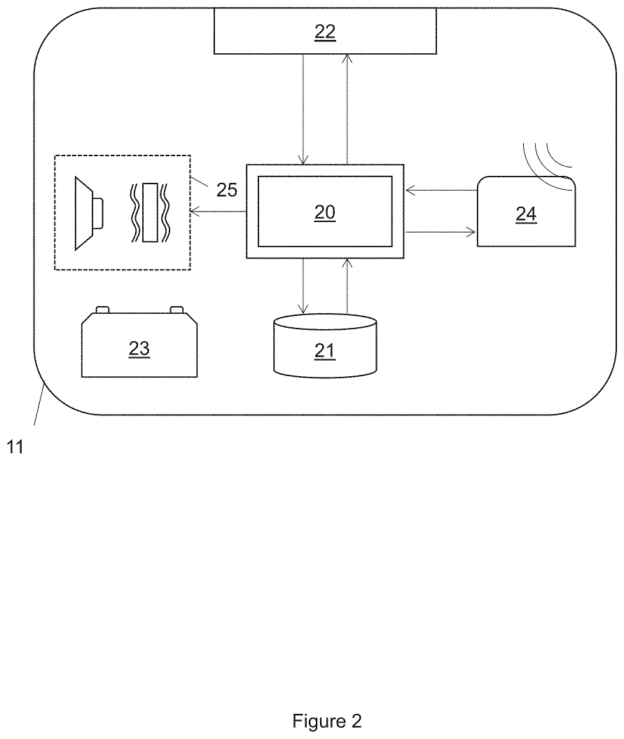

Referring to FIG. 2, each user device 11 comprises a processor 20 interfaced with a memory 21 and a wireless communication module 22. The memory 21 is configured with programming code configured to cause the processor 20 to implement the functionality described herein. The memory 21 typically also a program workspace to store dynamic information during operation of the user device 11. The processor 20 can comprise one or more central processing units. The wireless communication module 22 typically is configured to receive data from the server 12 via a relatively long-range (that is, greater than 10 metre) wireless communication. For the purposes of this description, the wireless communication module 22 is also configured to communicate data to the server 12. In an embodiment, the wireless communication module 22 also comprises functionality for short-range wireless communication, such as according to the Bluetooth standard (it should be understood that separate physical and/or logical components may provide the short-range and long-range communication). The user devices 11 also comprise power supply 23, typically in the form of a battery such as a lithium-ion battery.

Each user device 11 also comprises a locator 24 configured to provide the processor 20 with information indicating a current location of the user device 11. For example, the locator 24 may include a GPS receiver module. However, other locating means may be used, for example, the locator 24 may receive wireless signals from an arrangement of locating beacons (not shown) with known location with respect to the sports field 47 from which a determination of the current location can be made. The locator 24 provides, in a general sense, the current physical coordinates of the user device 11—for example, physical coordinates refer to those with respect to a positioning system such as GPS.

Each user device 11 further comprises a stimulus module 25 controllable by processor 20. The stimulus module 25 is configured to provide a stimulus to the player wearing a particular user device 11 when controlled to do so. In an embodiment, the stimulus module 25 provides an audible stimulus, for example, via a speaker. In an embodiment, the stimulus module 25 provides a vibratory stimulus, for example, via a vibrator.

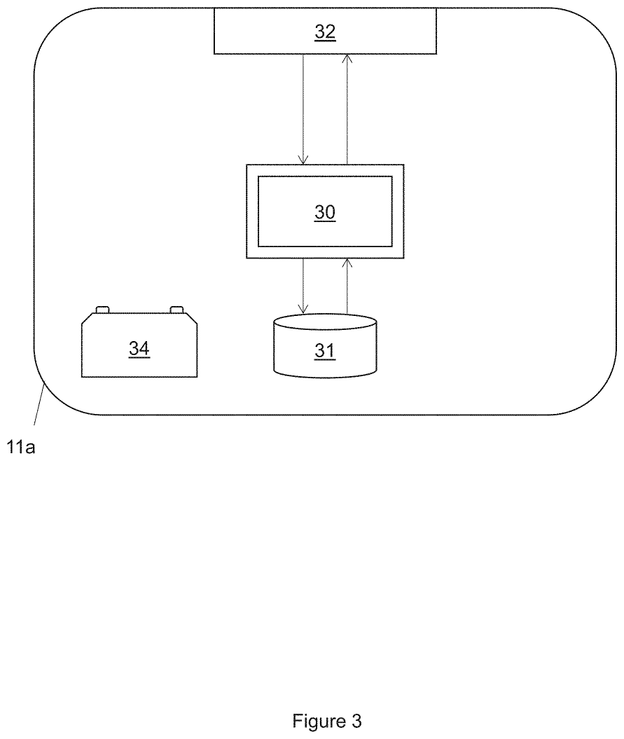

FIG. 3 shows an embodiment of the server 12 which comprises a processor 30 interfaced with a memory 31 and a wireless communication module 32. The memory 31 is configured with programming code to cause the server 12 to implement the functionality described herein. The memory 31 typically also comprises a program workspace to store dynamic information during operation of the server 12. The processor 30 can comprise one or more central processing units. The wireless communication module 32 typically is configured to receive data from the one or more user devices 11. For the purposes of this description, the wireless communication module 32 is also configured to communicate data to the user devices 11. The server 12 also typically comprises a power supply 33, typically in the form of a battery such as a lithium-ion battery.

It is expected that the server 12 will be implemented by a programmable portable device, such as a smartphone, tablet, or laptop. In this case, the server 12 may be provided by software downloaded and executed on the device (e.g. downloaded from an “App Store”). However, it is also envisaged that specialised hardware may be provided embodying the server 12. The server 12 may have some of its functionality implemented within a network structure, such as a cloud computing structure.

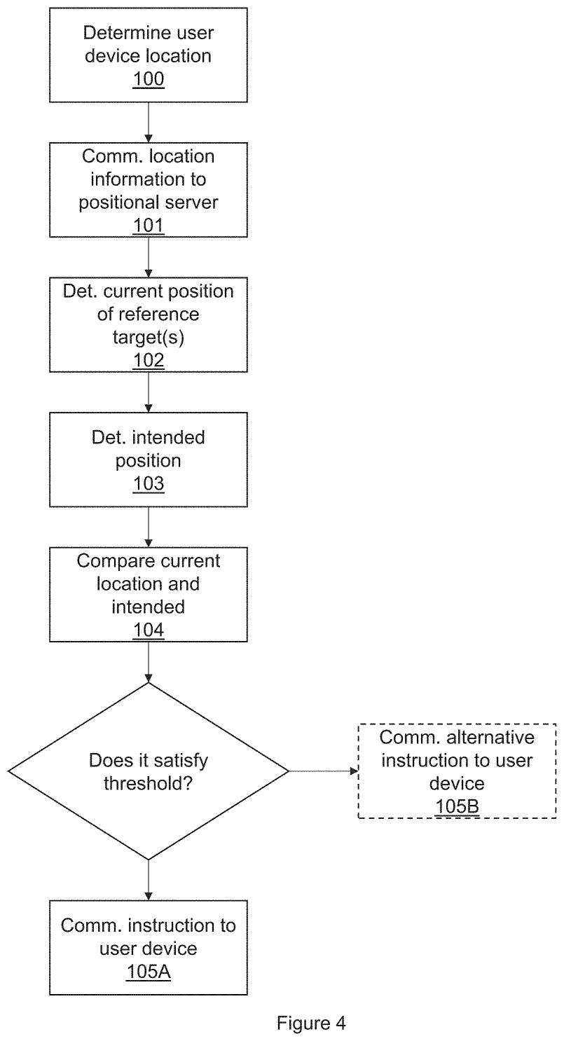

FIG. 4 shows an overview of a method for controlling a user device 11 within the system 10, according to an embodiment. Here, the user device 11 intermittently (for example, this could be periodically with a predefined period) determines its own location, at step 100. The determination is made in accordance with data generated by its locator 25—where the locator 25 comprises a GPS module, the determination may correspond to identifying current GPS coordinates.

The user device 11 then communicates location information indicating its determined location to the server 12, at step 101. The location information is communicated via wireless communication module 22 and received by wireless communication module 32. The location information is communicated in a manner to enable the receiving server 12 to determine the particular user device 11 associated with the location information. For example, the wireless communication protocol utilised may enable such a determination. Also, or alternatively, the location information is accompanied by user device ID information.

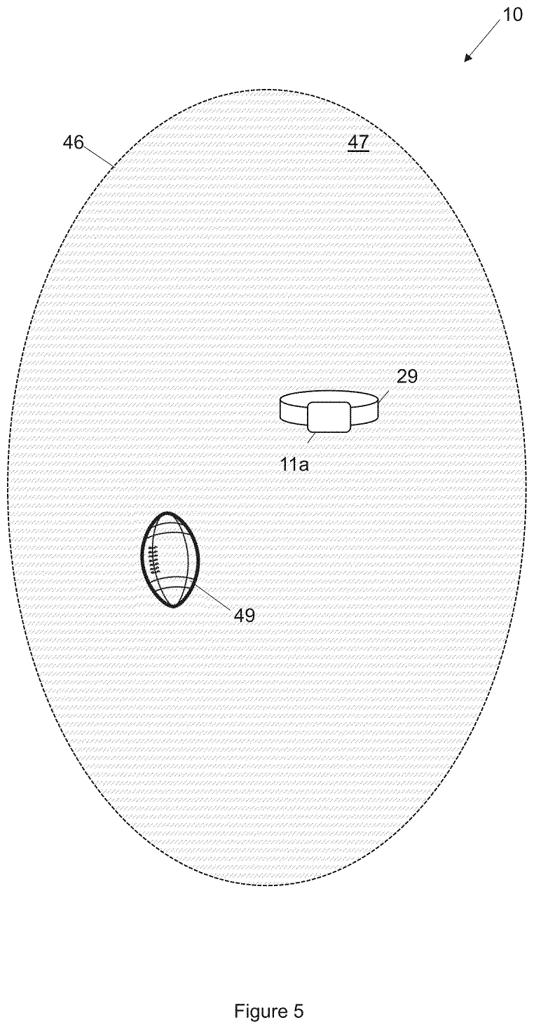

The server 12 is configured to identify a current location of at least one reference target 49, at step 102. Referring to FIG. 5, one reference target 49 is shown with respect to the sports field 47. Several different embodiments are disclosed herein relating the nature of the reference target 49, however, in a general sense, the reference target 49 comprises a location with respect to the sports field 47 from which a current location of a player 48 is compared (represented by user device lla in the figure).

In an embodiment (not shown), the reference target 49 corresponds to a fixed (at least fixed during coaching) physical object or location. For example, the reference target 49 can correspond to a goal post, goal area, etc. in a sports environment. Therefore, the current location can be determined simply from information pre-provided to the server 12. However, in another embodiment, the reference target 49 may move (at least, move during coaching).

In one embodiment (as shown in FIG. 5), the reference target is associated with a physical item 40 which is moveable (such as a ball). In this case, the location of the physical item 40 needs to be determinable by the server 12. In one implementation, the physical item 40 has attached to it a locator device 41 configured to determine its own location (and therefore that of the physical item 40) and to communicate this information to the server 12. The locator device 41 may comprise similar hardware to a user device 11. The locator device 41 can be configured to communicate the information on demand, that is, in response to receiving a request for its location information from the server 12. In another configuration, the locator device 41 intermittently (e.g. periodically with a predefined period) communicates the information to the server 12.

However, in another implementation, the physical item 40 is not suitable to hold a locator device 41 with hardware necessary to locate itself and communicate with the server 12. For example, where the physical item 40 is a ball, during use, it is typically hit with significant force which may damage such a locator device 41. In this implementation, the physical item 40 is provided with a relatively low complexity beacon device 42, for example, utilising Bluetooth Low Energy technology. An advantage of Bluetooth Low Energy (and similar technologies) is that the low energy and signal range requirements allows for relatively small and inexpensive form-factors. Additionally, form-factors are available providing a relatively high resistance to impact damage.

The beacon device 42 may be configured to emit a beacon signal intermittently, which is detectable by the user devices 11. For example, the beacon signal may be emitted periodically with a predefined period (assumed herein). Alternatively, for example, the beacon device 42 may be configured to emit a beacon signal in response to a request received by the beacon device 42 from a user device 11 (or another source). The beacon signal typically comprises a data packet (or multiple packets). Receiving user devices 11 typically are able to determine a Received Signal Strength Indication (RSSI) associated with the communicated data packet—i.e. with the beacon signal. The RSSI corresponds to a measurement of signal strength. It is understood that other measures of signal strength may be employed in addition or alternatively to the RSSI. The beacon signal may also comprise a beacon device ID, a unique (or at least, unique within the context of system 10) code (such as a number) associated with the beacon device 42. Therefore, the user devices 11 can be configured to also determine the particular beacon device 42, which may be particularly advantageous where system 10 comprises more than one reference target 49.

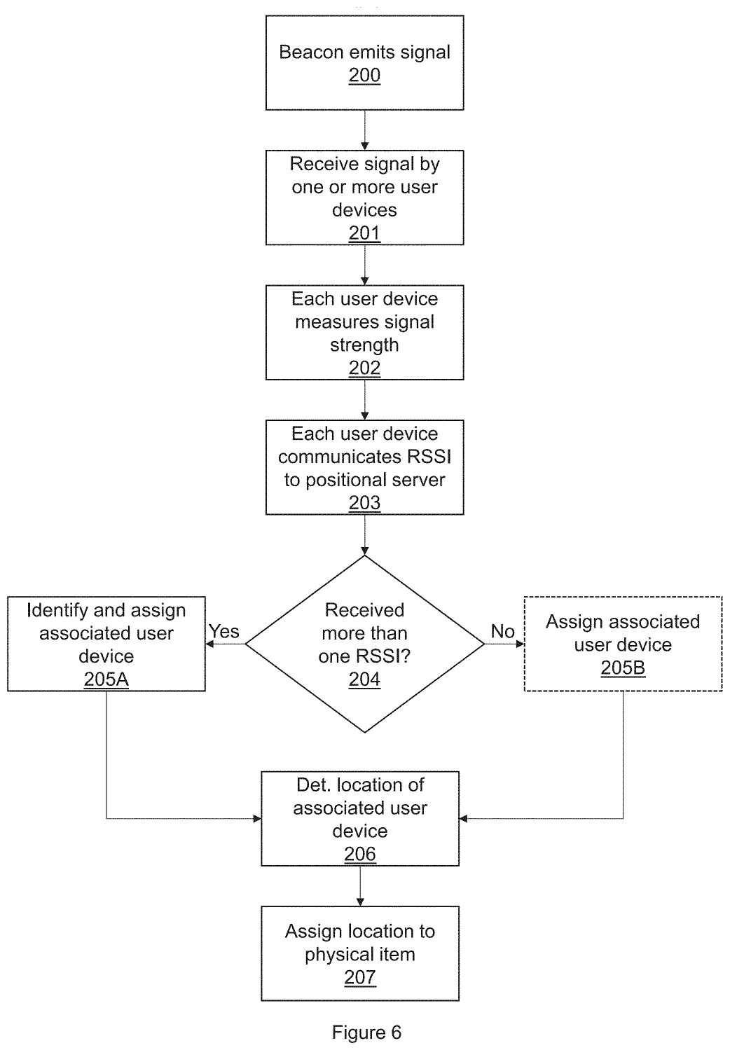

Referring to FIG. 6, a method is shown, according to an embodiment, for determining the location of a reference target 49 corresponding to a moveable physical item 40 having a beacon device 42.

At step 200, the beacon device 42 emits a beacon signal which is received by one or more nearby user devices 11, at step 201. “Nearby” here means within a range for detecting the beacon signal—this is typically dependent on a power setting of the beacon device 42 and other factors. Relevantly, the one or more nearby user devices 11 each determine a RSSI associated with the received beacon signal, at step 202. The RSSI values typically differ between the user devices 11.

The one or more nearby user devices 11 are then configured to communicate the determined RSSIs to the server 12, at step 203. Each RSSI is typically communicated such that the communicating user device 11 can be identified (i.e. the server 12 is configured to associate each received RSSI with the user device 11 ommunicating it). Other information may also be communicated, as required.

The server 12 then checks whether one RSSI has been received or more than one RSSI, at step 204. The server 12 may be configured to implement a preconfigured timeout beginning with receipt of a first RSSI—in this sense, the server 12 is configured to assume that all RSSIs associated with the one or more nearby user devices 11 are received within the timeout period. In particular, it is expected that not all user devices 11 of the system 10 are nearby user devices 11, and therefore, the server 12 cannot know how many RSSIs may be received.

If more than one RSSI is received (e.g. within the timeout period), the server 12 is configured to identify one user device 11 of the several user devices 11 to be an associated user device 11, at step 205A. The device 12 identifies, based on the received RSSIs, a closest user device 11 to the physical item 40—typically, this is assumed to be the user device 11 communicating the strongest RSSI (that is, the RSSI which can be interpreted as corresponding to the strongest received signal). As discussed, other measures instead of the RSSI can be used—in such case, the server 12 is still configured to identify a user device 11 receiving a strongest beacon signal from the beacon device 42. The closest user device 11 is then assigned to be the associated user device 11. It should be understood that similar RSSIs may result in a user device 11 being selected which is not necessarily exactly the closest user device 11 (various physical factors can affect the RSSI measurement). However, it is expected that in such situations the relative location of the physical item 40 can still be determined with sufficient accuracy for implementing the functionality herein described. If one RSSI is received, then the user device 11 associated with that RSSI is assigned to be the associated user device 11, at step 205B.

In either case, once the associated user device 11 is assigned, the method proceeds to determining the current location of the associated user device 11, at step 206. The current location can be determined according to several techniques. In one embodiment, the server 12 has a most recent known location of the associated user device 11 in memory (e.g. as a result of steps 100 and 101 of the method of FIG. 4) and uses this location as the current location of the associated user device 11. In another embodiment, the nearby user devices 11 are each configured to communicate their current location (determined according to their locators 25) when communicating the RSSI to the server 12, such that the current location of the associated user device 11 can simply be identified from the communicated current location. In another embodiment, after determining the associated user device 11, the server 12 requests (and receives) the current location of the associated user device 11 from the associated user device 11.

In any event, once the current location of the associated user device 11 is known, the server 12 sets the location of the reference target 49 associated with the physical item 40 to be same as the current location of the associated user device 11, at step 207.

Referring back to FIG. 4, the server 12 then determines one or more intended locations for the user device 11 (and therefore, player 48) which are locations to which the player 48 is intended to position themselves, at step 103. The determination includes applying a structure model to the location of the reference target 49. A structure model, as used herein, is a predefined ruleset configured to enable calculation of the one or more intended locations, where the predefined ruleset is provided to the server 12 before application of the presently described method. Therefore, the one or more intended locations are determined, at least in part, based on the determined location of the reference target 49. In embodiments, the one or more intended locations are determined, at least in part, based on the current location of the user device 11 (and therefore player 48). Thus, in an embodiment, a user device 11 may be associated with a plurality of intended locations. In this case, the player 48 effectively has a choice of possible locations to place themselves with respect to the reference target 49.

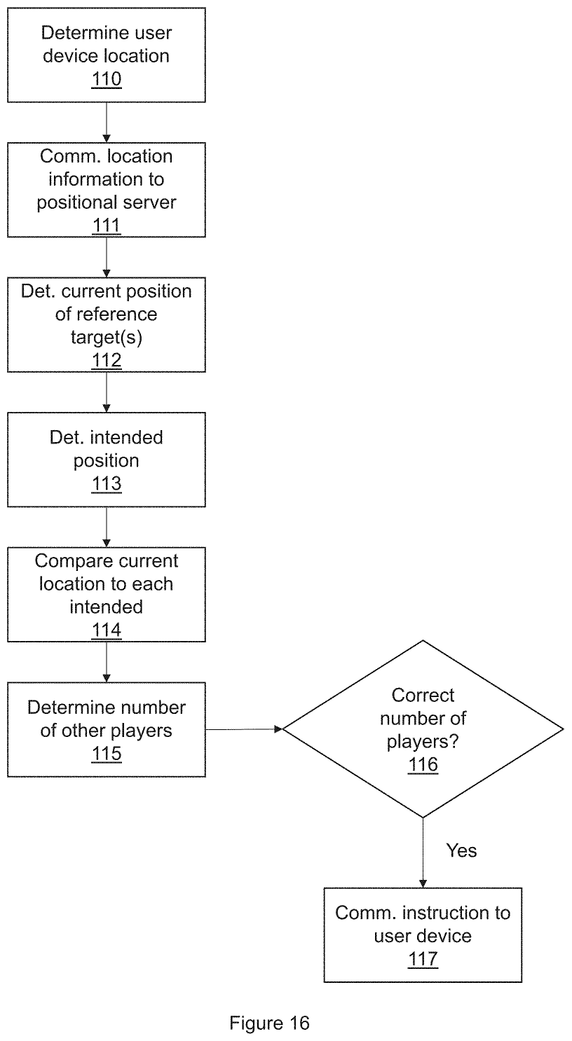

FIG. 4 relates to an embodiment wherein one intended location is determined for the user device 11. FIG. 16, discussed below, relates to an embodiment wherein one or more intended locations can be determined for each user device 11.

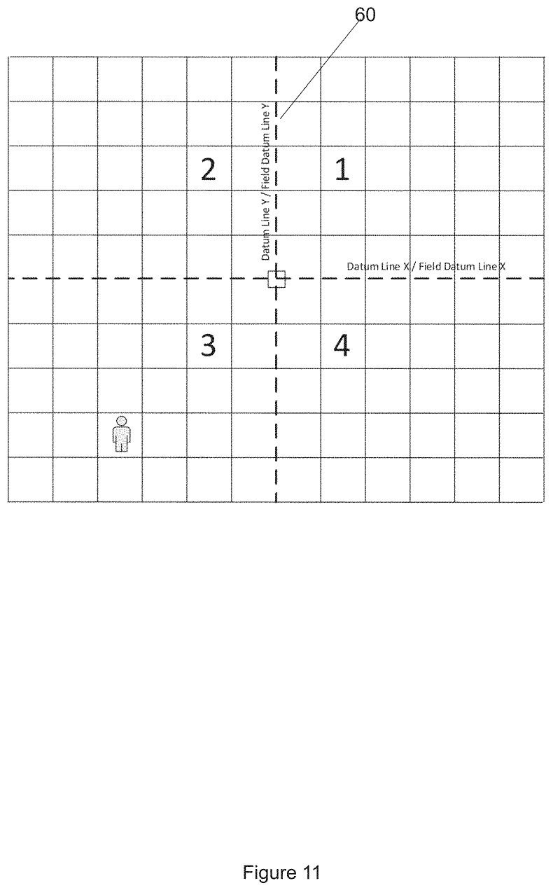

Referring back to FIG. 4, the server 12 then compares the location of the user device 11 to the intended location, at step 104. The server 12 is configured to identify, as a result of the comparison, whether the difference between the location of the user device 11 and the intended location meets a predefined threshold. In a general sense, the predefined threshold can correspond to the difference being within a threshold distance or outside of a threshold distance (depending on the embodiment). The difference may be quantised as described in relation to FIG. 11. For example, the predefined threshold may correspond to the distance being within 10 metres, or more preferably, within 5 metres. In another example, the predefined threshold may correspond to the distance being outside of 10 metres, or more preferably, outside of 5 metres. In an alternative conceptual implementation, the threshold distance may incorporate into the intended location—for example, the intended location may define an area in which the player 48 should be located.

If the predefined threshold is met, the server 12 is configured to communicate an instruction to the user device 11 indicating that the threshold has been met, at step 105A. In response to receiving the instruction, the user device 11 is configured to control its stimulus module 26 to provide a stimulus to the player 48 wearing the user device 11. Thus, depending on the embodiment, the player 48 receives the stimulus in response to being within the threshold distance or outside of the threshold distance. In both embodiments, the player 48 is provided with information indicating the player's location with respect to the intended location for the player.

Optionally (depending on the embodiment), the server 12 can be configured to communicate an alternative instruction to the user device 11 indicating that the predefined threshold has not been met, at step 105B. In the figure, the optional step is shown with a dotted-line border. Step 105B may be advantageous where the user devices 11 are configured to undertake an action when both within and outside of the threshold—for example, different audible and/or vibrational stimuli might be emitted by the user device 11 in dependence on whether the player 48 is in the correct location or not.

Accordingly, embodiments of the present invention advantageously provide feedback to one or more players 48 as to their positioning with respect to their intended positions according to the location of the one or more reference targets 49 and the predefined structure model. It should be understood that the method of FIG. 4 can be repeated for a plurality (e.g. all) of the players 48 present (and therefore, each user device 11)—generally, step 102 may be performed once by the server 12 in respect of a plurality of the user devices 11.

The structure model may incorporate an assessment of the locations of one or more other user devices 11 when determining the one or more intended locations for a particular user device 11. For example, it may be that if another user device 11 (i.e. player 48) is already at a particular location, a different intended location is determined for the current user device 11.

Referring to FIG. 16, in an embodiment, a user device 11 may be associated with a plurality of intended locations. According to this embodiment, however, a player proximity rule is included as part of the predefined threshold. For example, according to this embodiment, the predefined threshold is dependent on a comparison between the locations of the particular user device 11a and one or more other user devices 11b-11e as well as a determination of one or more intended locations.

The player proximity rule can be user defined and can specify a maximum, minimum, or range of number of user devices 11a-11e that can be within one of the one or more intended locations. For example, it may be that only one player 48 is to be at a particular intended location, but that the particular player 48 at that location may be selected from a plurality of the players 48—in this case, the player proximity rule specifies that one user device 11 is to be at the location. Therefore, according to an embodiment utilising a player proximity rule, the server 12 is configured to determine relative locations of one or more other user devices 11b-11e to a particular user device 11a.

An advantage of the present embodiment may be that players 48 are trained to work with one another to ensure that there are players 48 at each of one or more intended locations without specifying which player 48 is at the, or each, intended location. From a particular player's perspective, they are trained to move towards one of a plurality of possible locations while ensuring that a correct number of players are at each intended location.

FIG. 16 shows a modification to the method of FIG. 4, steps 110-113 correspond to steps 100-103 of FIG. 4.

The server 12 compares the location of the user device 11 to each of the intended locations, at step 114. The server 12 is configured to identify, as a result of the comparison, whether the difference between the location of the user device 11 and each of the intended locations meets a predefined threshold. According to this embodiment, it may be preferred that each intended location is sufficiently separated such that the predefined threshold does not result in overlap between two or more intended locations. As with the embodiment of FIG. 4, in a general sense, the predefined threshold can correspond to the difference being within a threshold distance or outside of a threshold distance (depending on the embodiment). The difference may be quantised as described in relation to FIG. 11. For example, the predefined threshold may correspond to the distance being within 10 metres, or more preferably, within 5 metres. In another example, the predefined threshold may correspond to the distance being outside of 10 metres, or more preferably, outside of 5 metres.

If the user device 11 is within the threshold distance of a particular intended location, the server 11 then checks as to whether any other user devices 11b-11eare also at the intended location (e.g. within the threshold distance of the intended location), at step 115.

The server 11 then determines the number of user devices 11 (e.g. the user device 11a and the one or more other user devices 11b-11e, if applicable) and applies the player proximity rule to determine if an incorrect number of user devices 11 are at the intended location, at step 116. In an example, the player proximity rule specifies that only one user device 11 should be at an intended location—therefore, should any other user device 11b-11e be at the intended location, the server 11 will determine that an incorrect number of user devices 11 are present. If the number of user devices 11 meets the requirement of the player proximity rule, then the server 11 determines that the predefined threshold is met.

If the predefined threshold is met, the server 12 is configured to communicate an instruction to the user device 11 indicating that the threshold has been met, at step 117. In response to receiving the instruction, the user device 11 is configured to control its stimulus module 26 to provide a stimulus to the player 48 wearing the user device 11. Thus, depending on the embodiment, the player 48 receives the stimulus in response to the server 11 determining whether the predefined threshold is or is not met. In both embodiments, the player 48 is provided with information indicating the player's location with respect to the intended location for the player. Optionally (depending on the embodiment), the server 12 can be configured to communicate an alternative instruction to the user device 11 indicating that the predefined threshold has not been met—similar to as described with respect to FIG. 4.

The methods described with reference to FIGS. 4, 6 and 16 rely upon a determination of a relative location between one or more players 48 (via user devices 11), one or more reference targets 49, and the bounded area 47.

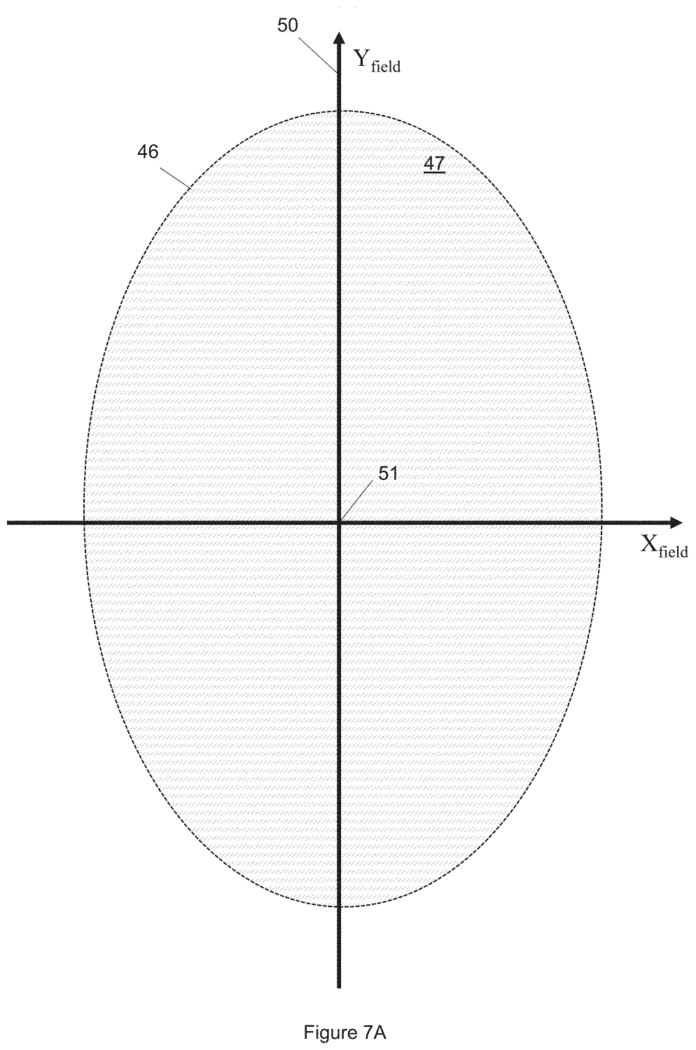

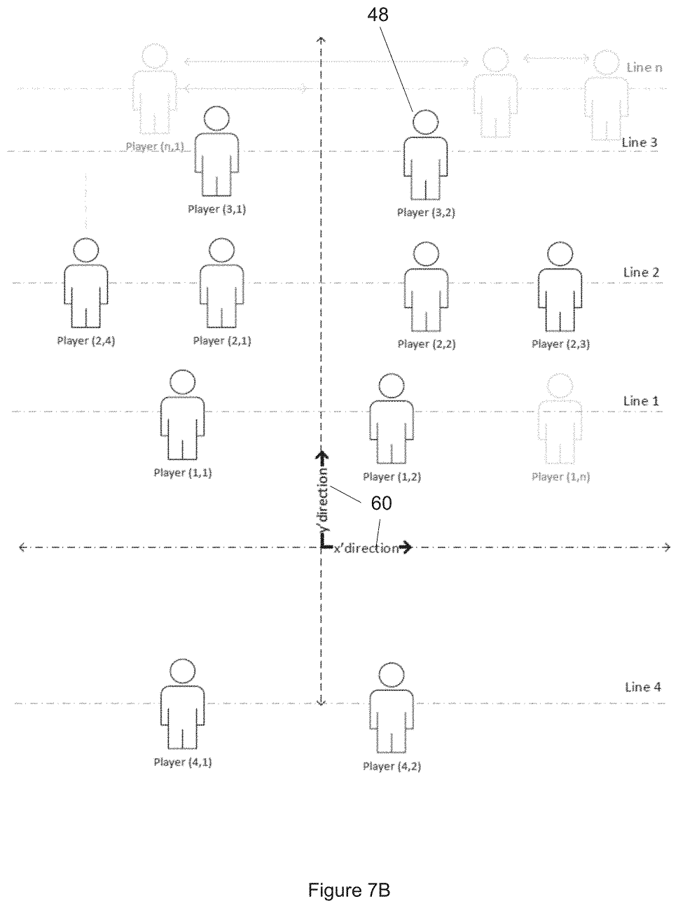

In an embodiment, with reference to FIGS. 7A and 7B, the server 12 is configured to operate a Cartesian field coordinate system 50 having an x-axis (X_{field}) and y-axis (Y_{field}) (see FIG. 7A) and a Cartesian team coordinate system 60 having an x-axis (Xₜₑₐₘ) and a y-axis (Yₜₑₐₘ) (see FIG. 7B).

Referring to FIG. 7A, the field coordinate system 50 is fixed with respect to the bounded area 47—in an implementation, the origin 51 of the field coordinate system 50 (“field origin 51”) is located at, or close to, the centre of the bounded area 47. Typically, where the bounded area 47 comprises an obvious (that is, obvious to a user) long axis and short axis, the x-axis (X_{field}) and y-axis (Y_{field}) of the field coordinate system 50 can be aligned with the long axis and the short axis. Although arbitrary, for the purposes of this disclosure, it is assumed that the field coordinate system 50 has its y-axis (Y_{field}) assigned to a long axis and its x-axis (X_{field}) assigned to a short axis (as shown with respect to an oval-shaped bounded area 47).

Referring to FIG. 7B, the team coordinate system 60 defines the relative positions between players 48 (i.e. it records player location in a relative way). In an embodiment, the team coordinate system 60 is fixed with respect to the field coordinate system 50. In another embodiment, the team coordinate system 60 may move with respect to the field coordinate system 50—this latter embodiment is primarily described herein, however, it should be understood that aspects of the disclosure apply to the former embodiment. The team coordinate system 60 may provide an advantageous coordinate system for defining team structure—that is, the team coordinate system 60 may assist a coach (or other user) in defining a structure model as it is suitable for specification of relative player positions. In this way, the interaction between the team coordinate system 60 and the field coordinate system 50 may advantageously facilitate the application of a structure model to actual player positions on the field (i.e. within the boundary area 47).

Referring back to the field coordinate system 50 shown in FIG. 7A, it is possible to utilise the raw output of the user device locators 25 to define the positions in the field coordinate system 50—for example, the coordinates may correspond to that of Universal Transverse Mercator (UTM) coordinate system provided by a GPS receiver. However, it is generally preferred to introduce a coordinate transform such that the origin of the field coordinate system 50 is present within the bounded area 47 or at least in the close vicinity.

FIG. 7A includes boundary 46 which acts to demarcate the bounded area 47 from “out-of-bounds” locations (i.e. outside of the field of play). The boundary 46 is required to be specified in terms of the field coordinate system 50 such that it can be incorporated into the determination of the intended location.

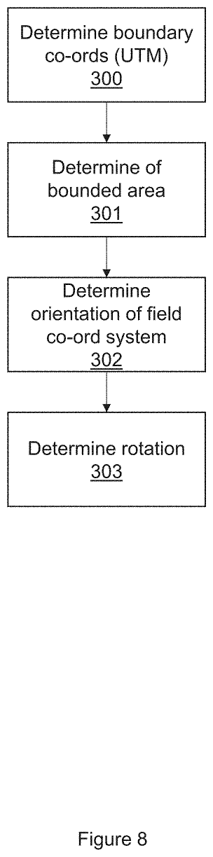

According to an embodiment, with reference to FIG. 8, first the coordinates defining the boundary 46 are determined, at step 300.

One option for determining the boundary coordinates is to record a number of points of the boundary 46 using a locator 25. For example, a user may take a user device 11 (or a device having similar functionality) and walk (or otherwise move) around the boundary 46. The user device 11 is configured to regularly communicate to the server 12 its current location such that a map or survey of the actual location of the boundary 46 is stored in the memory 32 of the server 12. The coordinates defining the boundary 26 can be stored as raw results from the locator 25—e.g. if UTM is used then as “northing” (N) and “easting” (E) coordinates.

Another option for determining the boundary coordinates is suitable for easily definable boundary 46 shapes—e.g. a rectangular soccer field. In this case, the user device 11 can simply communicate its location when present at the four corners of the field to define the coordinates of the boundary 46—the coordinates between these four coordinates can be calculated assuming straight lines connect them.

Next, at step 301, the centre of the bounded area 47 is determined as the origin of the field coordinate system 50. Generally, any point relative to the bounded area 47 can be assigned the origin—choosing the centre may provide an advantage in ease of use. For example, although the centre is chosen here, other points either inside or outside of the boundary 46 may be selected as the origin. In one implementation (not shown), the origin is set such that all positions of the bounded area 47 are associated with positive coordinate values.

The following equation may be suitable for identifying the centre of the bounded area 47:

$$\overline{N} = \frac{{Σ}_{i = 0}^{n - 1} ( {N}_{b , i} + {N}_{b , i + 1} ) \times ( {N}_{b , i} \times {E}_{b , i + 1} - {N}_{b , i + 1} {E}_{b , i} )}{3 \times {Σ}_{i = 0}^{n - 1} ( {N}_{b , i} \times {E}_{b , i + 1} - {N}_{b , i + 1} {E}_{b , i} )} \\ \overline{E} = \frac{{Σ}_{i = 0}^{n - 1} ( {E}_{b , i} + {E}_{b , i + 1} ) \times ( {N}_{b , i} \times {E}_{b , i + 1} - {N}_{b , i + 1} {E}_{b , i} )}{3 \times {Σ}_{i = 0}^{n - 1} ( {N}_{b , i} \times {E}_{b , i + 1} - {N}_{b , i + 1} {E}_{b , i} )} \qquad Eq . 1$$

Here, Ē and N̅ are the easting and northing coordinates of the origin 51 (i.e. the centre of the field), and E_{b,i} and N_{b,i} are each measured point on the boundary 46. The value of i runs from 0 to n-1. According to the notation, n is equal to the number of boundary 46 measurements made. The boundary 46 is assumed to be closed such that i+1=n refers to the point i=0.

Therefore, as a result of Eq. 1, the origin 51 of the field coordinate system 50 is known with respect to the coordinate system of the locator 25 and is located at the centre of the bounded area 46. In another embodiment, the user is able to manually set the origin 51. For example, the user may move a user device 11 to an approximate centre of the bounded area 46 and communicate a coordinate to the server 11 specifying that coordinate as the origin 51.

Then, at step 302, the orientation of the field coordinate system 50 with respect to the coordinate system of the locator 25 is determined. Generally, there can be different approaches to this determination—in the present example, it is desired that the x-axis (X_{field}) bisects the origin 51 and extends in the direction corresponding to the shortest distance between the origin 51 and the boundary 46. The following equations may be used to determine the orientation of the x-axis:

D_{ob}=\sqrt{ΔE_{b}²−ΔN_{b}²}ΔE_{b}=E_{b}−ĒΔN_{b}=N_{b}−N̅ Eq. 2

Again, Ē and N̅ are the easting and northing coordinates of the origin 51, and E_{b} and N_{b} are the coordinates of the boundary 46 (as variables). Generally, it may be assumed that the boundary 46 comprises straight-line segments connecting each pair of adjacent measured points (e.g. a straight line connecting (Eᵢ₊₁,Nᵢ₊₁) to (Eᵢ₊₁,Nᵢ₊₁)). D_{ob} is the distance between the origin 51 and a point (E_{b},N_{b}) on the boundary 46.

The values for E_{b} and N_{b} are stored in memory 32 where the value of D_{ob} is a minimum—that is, these values correspond to the location on the boundary 46 closest to the origin 51. These minimum values can be labelled E_{b,min} and N_{b,min}.

At step 303, a rotation θ_{field} is determined between the field coordinate system 50 and the coordinate system of the locator 25—that is, it is expected that origin 51 and the location on the boundary 26 of the shortest distance will not form a parallel line to an axis of the coordinate system of the locator 25. The following equations may be suitable for finding this angle:

$$\begin{matrix}{θ}_{field} = {tan}^{- 1} ( \frac{{N}_{b , min} - \overline{N}}{{E}_{b , min} - \overline{E}} ) , where \\ {E}_{b , min} - \overline{E} > 0 & Eq . 3 A \\ {θ}_{field} = {tan}^{- 1} ( \frac{{N}_{b , min} - \overline{N}}{{E}_{b , min} - \overline{E}} ) + {180}^{°} , where \\ {E}_{b , min} - \overline{E} < 0 , \\ {N}_{b , min} - \overline{N} > 0 & Eq . 3 B \\ {θ}_{field} = {tan}^{- 1} ( \frac{{N}_{b , min} - \overline{N}}{{E}_{b , min} - \overline{E}} ) - {180}^{°} , where \\ {E}_{b , min} - \overline{E} < 0 , \\ {N}_{b , min} - \overline{N} < 0 & Eq . 3 C\end{matrix}$$

Regarding player locations, it should be noted that the user devices 11 worn by the players 48 provide the same output as that used to define the origin 51, boundary 46, and rotation θ_{field}. Therefore, the server 12 is generally configured, in this embodiment, to convert received player locations to the field coordinate system 50. For an individual player, the following equations may be suitable to map to the field coordinate system 50:

X_{P,rel}=E−ĒY_{P,rel}=N−N̅X_{P,field}=X_{p,rel}COSθ_{field}+Y_{p,rel}Sinθ_{field}Y_{P,field}=−X_{p,rel}Sinθ_{field}+Y_{p,rel}COSθ_{field} Eq. 4

Here, X_{P,rel} and Y_{P,rel} are the coordinates of the player 48 in UTM units but relative to the origin 51—that is, the coordinates of the player 48 determined from their associated locator 25 and adjusted according to the location of the origin 51. X_{p,field} and Y_{P,field} are the coordinates of the player 48 in the field coordinate system 50.

When considering a plurality (n) of players 48, the Eq. 4 can be expressed in matrix form, for example the following form may be suitable:

$$[ \begin{matrix}{X}_{P , f , 1} & {Y}_{P , f , 1} \\ {X}_{P , f , 2} & {Y}_{P , f , 2} \\ ⋮ & ⋮ \\ {X}_{P , f , n} & {Y}_{P , f , n}\end{matrix} ] = [ \begin{matrix}{X}_{P , rel , 1} & {Y}_{P , rel , 1} \\ {X}_{P , rel , 2} & {Y}_{P , rel , 2} \\ ⋮ & ⋮ \\ {X}_{P , rel , n} & {Y}_{P , rel , n}\end{matrix} ] [ \begin{matrix}cos {θ}_{field} & - sin {θ}_{field} \\ sin {θ}_{field} & cos {θ}_{field}\end{matrix} ] \qquad Eq . 5$$

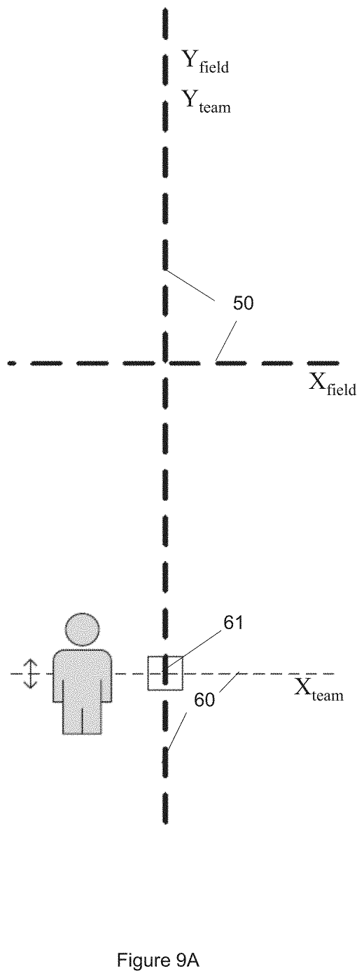

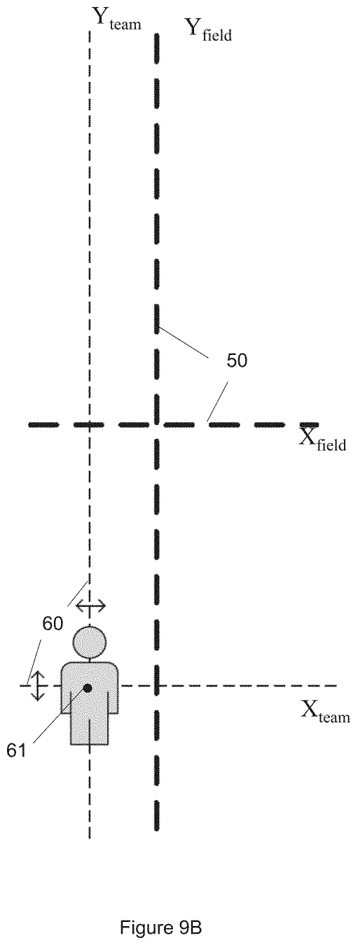

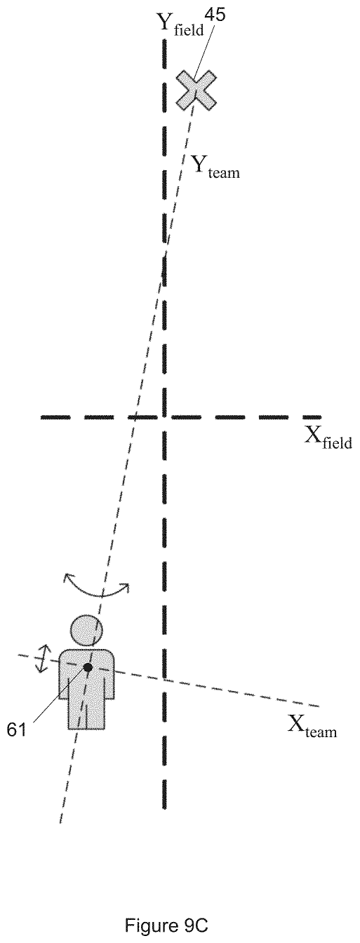

Referring to FIGS. 9A-9C, coordinate transforms for converting between the field coordinate system 50 and the team coordinate system 60 are described for different embodiments in which the relation between the coordinate systems 50, 60 can change.

FIG. 9A shows a coordinate transform where the team coordinate system 60 is able to move with respect to one axis of the field coordinate system 50 but not the other. To illustrate the embodiment, it is assumed that the origin 61 can move with respect to the y-axis (Y_{field}) but not the x-axis (X_{field}). The origin 61 therefore has a fixed location with respect to the x-axis (X_{field}) which for convenience is assumed to be zero (that is, the axes Y_{field} and Yₜₑₐₘ are the same as shown). However, the origin 61 does not have a fixed location with respect to the y-axis (Y_{field}) and therefore the axis Xₜₑₐₘ can move up and down the axis Y_{field}. The following equations may be used to calculate the location of the player 48 in the team coordinate system 60 with respect to the field coordinate system 50:

Y_{P,team}=Y_{P,field}+Y_{team,field}X_{P,team}=X_{P,field} Eq. 6

Here, Y_{p,team} and X_{P,team} are the coordinates of the player 48 in the team coordinate system 48 and Y_{team,field} is the position of the origin 61 in the field coordinate system 50.

FIG. 9B shows a coordinate transform where the team coordinate system 60 is able to move with respect to both axes. To illustrate the embodiment, it is assumed that the origin 61 can move with respect to the y-axis (Y_{field}) and the x-axis (X_{field}).The following equations may be used to calculate the location of the player 51 in the team coordinate system 60 with respect to the field coordinate system 50:

Y_{P,team}=Y_{P,field}+Y_{team,field}X_{P,team}=X_{P,field}+X_{team,field} Eq. 7

Here, Y_{p,team} and X_{p,team} are the coordinates of the player 48 in the team coordinate system 48 and Y_{team,field} and X_{team,field} are the coordinates of the origin 61 in the field coordinate system 50.

It should be noted, for both FIGS. 9A and 9B, that the orientation of the team coordinate system 60 is not changeable with respect to the field coordinate system 50—in the examples shown, it is assumed that the coordinate systems 50, 60 are parallel.

FIG. 9C shows a coordinate transform where the team coordinate system 60 is able to move with respect to both axes and is able to change orientation with respect to the field coordinate system 60. To illustrate the embodiment, it is assumed that the origin 61 can move with respect to the y-axis (Y_{field}) and the x-axis (X_{field}).

In the embodiment, one of the axes of the team coordinate system 60 (i.e. one of Yₜₑₐₘ and Xₜₑₐₘ) is rotated such that it bisects the location of a particular coordinate of the field coordinate system 50 (“stationary target 45”)—typically, a location corresponding to a station structure such as a goal area. In the example shown, the axis Yₜₑₐₘ is selected to bisect the stationary target. According to this embodiment, it is necessary to know the origin 61 of the team coordinate system 60 with respect to the field coordinate system 50.

In the figure, the origin 61 of the team coordinate system 60 with respect to the field coordinate system 50 is located at (X_{tea,field},Y_{team,field}). The rotation, θ, as shown in the figure describes the angle at which the x-axis (Xₜₑₐₘ) of the team coordinate system 60 intersects with the y-axis (Y_{field}) of the field coordinate system 50. The following equations may be suitable for finding the angle θ:

$$\begin{matrix}θ = {tan}^{- 1} ( \frac{{Y}_{goal , field} - {Y}_{team , field}}{{X}_{goal , field} - {X}_{team , field}} ) - {90}^{°} , where \\ {X}_{goal , field} - {X}_{team , field} > 0 & Eq . 8 A \\ θ = {tan}^{- 1} ( \frac{{Y}_{goal , field} - {Y}_{team , field}}{{X}_{goal , field} - {X}_{team , field}} ) + {90}^{°} , where \\ {X}_{goal , field} - {X}_{team , field} < 0 , \\ {Y}_{goal , field} - {Y}_{team , field} > 0 & Eq . 8 B \\ θ = {tan}^{- 1} ( \frac{{Y}_{goal , field} - {Y}_{team , field}}{{X}_{goal , field} - {X}_{team , field}} ) - {270}^{°} , where \\ {X}_{goal , field} - {X}_{team , field} < 0 , \\ {Y}_{goal , field} - {Y}_{team , field} < 0 & Eq . 8 C\end{matrix}$$

Here, Y_{goal,field} and X_{goal,field} are the coordinates of the stationary target 45 in the field coordinate system 50 and Y_{team,field} and X_{team,field} are the coordinates of the origin 61 of the team coordinate system 60 in the field coordinate system 50. Now, knowing the values for Y_{team,field}, X_{team,field}, and θ, it is possible to convert between the team coordinate system 60 and the field coordinate system 50 for any particular player 48 (or other object). For example, the following equations may be suitable:

Y_{P,team}=(−(X_{P,field}+X_{team,field})sin(θ)+(Y_{P,field}+Y_{team,field})COS(θ)) X_{P,team}=((X_{P,field}+X_{team,field})COS(θ)+(Y_{P,field}+Y_{team,field})sin(θ)) Eq. 9

The embodiment of FIG. 9C may be advantageous as it allows team structure to be defined by a coach (or other user) according to a relative orientation between the physical item 40 (e.g. a ball) and the stationary target 45 (e.g. goal posts).

It should be apparent that relations for finding a location within the field coordinate system 50 from a specified location within the team coordinate system 60 follow as inverses of the above equations.

In an embodiment, the team coordinate system 60 can be define with length scales such as to be congruent with the field coordinate system 50−for example, 100 m in the team coordinate system 60 may translate to 100 m in the field coordinate system 50—this is assumed above (the field coordinate system 50 and team coordinate system 60 are related via translations and/or rotations, and not scale changes).

In an embodiment, the team coordinate system 60 is defined for a nominal scale and a scaling factor is incorporated when converting between the field coordinate system 50 and the team coordinate system 60 (and vice versa). This may be useful where a coach defines a structural model in terms of real distances—these distances can also be modified according to the scaling factor. According to an embodiment, each coordinate can be assigned a different scaling factor.

According to an embodiment, a scaling factor or factors are determined in dependence on a position of the reference target 49. For example, where the reference target 49 is a ball, the scaling factor or factors may be determined in accordance with a relative distance between the reference target 49 and another feature or features—for example, a boundary or goalpost. A scaling factor can be determined for each axis. Alternatively, two scaling factors may be determined for each axis—one applying to a negative portion of the axis and another applying to a positive portion of the axis (in this example, four scaling factors may be determined). For example, where the reference target 49 is near a boundary, the team coordinate system may effectively be reduced in size in the direction of the boundary from the reference target 49 and expanded in size in the opposite direction.

Generally, the server 12 is configured to identify a structure model before a training exercise for the one or more players 48 associated with the training exercise—for example, a sports team. However, it should be understood that the particular structure model may be changed during training. Typically, the particular structure model is selected by a coach (although, again, this should not be considered limiting—in a broad sense, a user of the server 12 is enabled to select a particular structure model). The structure models may be preloaded into the memory 32 of the server 12 or may be created via user (e.g. coach) input at the time (and stored in memory 32). A structure model is configured to enable determination of an intended location for each player 48 based on a current location of one or more reference targets 49.

Players 48 may be coached to take up particular relative positions during particular scenarios during gameplay. An exemplary situation is one corresponding with a stoppage of play. For example, in Australian Rules Football, a stoppage may correspond to an opposition kick-in. In another example, in soccer, a stoppage may correspond to a free kick or throw-in. The coach may direct the players 48 to take up relative positions with respect to a location on the field—in the examples cited, this may be the location where the ball is put back into play. Thus, the intended location for each player 48 is determined based on this location on the field.

Typically, the structure model defines a rule to determine an intended location for each player 48—i.e. each player's intended location is unique to them. However, it is envisaged that two or more players 48 may be associated with the same intended location.

The structure model may take into account a player's current role—that is, the intended location for a particular player 48 may depend on that player's current role within the team. For example, in Australian Rules Football, a player may be a full forward or a centre depending on the game circumstance, and the intended location would depend on the current role of the player 48. The structure model may include a number of other dependencies when assigning an intended location to a player—for example, which part of the field the player is in, what time during the game the event takes place, whether the player's team is ahead or behind in the score (and by how much), etc.

A structure model may define a plurality of locations for a particular player 48 to locate themselves for a game circumstance, with the player 48 deciding which location to move towards. The player 48 may be trained to move to one of the plurality not presently occupied by another player 48.

A structure model may define rules for selecting one of a plurality of different intended locations for a particular player in dependence on a position of the reference target 49. For example, where the reference target 49 is a ball, the particular intended location may be determined in accordance with a relative po0sition between the reference target 49 and another feature or features—for example, a boundary or goalpost. In an embodiment, a direction between the current position of the reference target 49 and the other feature(s) may be utilised when determining the intended location. In an embodiment, a relative distance may be taken into account.

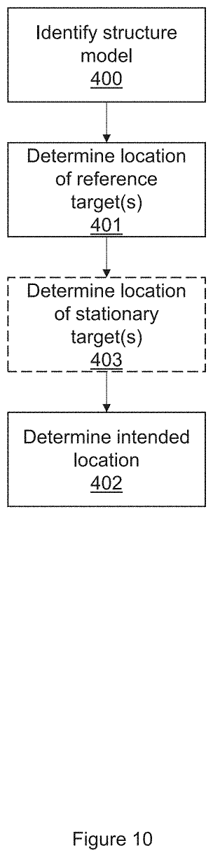

FIG. 10 shows an overview of the application of a structure model, according to an embodiment. The method may correspond to steps taken with regard to step 103 of FIG. 4—that is, determining the intended position of a player 48. The server 12 first identifies the particular structure model to apply—e.g. the structure model selected by the coach for the particular training instance—at step 400.

At step 401, the determined location of the one or more reference targets 49 are input to the structure model. Usually, each reference target 49 (where a plurality are involved) is identified to the structure model as the model may be dependent on the specific reference target locations.

The structure model may be configured to account for the location of reference targets 49 which are stationary—these can be referred to as stationary targets, at optional step 403—for example, goal posts in Australian Rules Football and soccer. These can be accounted for in several ways. In one, the structure model assumes the position of the stationary targets (e.g. based on the field coordinate system 50). Another technique is for the server 12 to identify the coordinates of the stationary targets 45 in the field coordinate system 50 (as these will not move with respect to this coordinate system) and to, as needed, calculate the coordinates of the stationary targets 45 in the team coordinate system 60. In this latter case, as the team coordinate system 60 moves with respect to the field coordinate system 50, the coordinates of the stationary targets 45 will change despite not moving. The coordinate transform can be as explained above with reference to FIGS. 9A-9C.

The structure model then determines the intended location as a relative location to the one or more reference target(s) 49 and/or one or more stationary targets (if this option is used), at step 402. In one example, a player's intended location is determined as being in a relative distance and angle from a reference target 49 (which may correspond to, for example, a ball)—for example, a full forward player in Australian Rules Football may be required to be a specified number of metres forward of the ball (and possibly to the left or right of the ball, depending on the particular location of the ball). Another player's intended position may be 10 metres directly behind the ball (for example).

Referring to FIG. 11, in an embodiment, the structure model considers the team coordinate system 60 as being divided into discrete zones—therefore, the intended location may be defined as one of the discrete zones and the position of the one or more of the reference targets 49 may be defined as one of the discrete zones. This embodiment may advantageously simplify structure model design—the coach can simply define where each player's indented position would be for each zone (and in fact, the same indented position can be associated with the reference target 49 being present in any one of a plurality of zones).

In an example implementation of this embodiment, the team coordinate system 60 and the field coordinate system 50 are the same—the server 12 may in fact be configured to treat these as one coordinate system. Thus, in this implementation, the coach may define the intended location with respect to stationary targets, e.g. goals, without concern being had for the stationary target location changing within the team coordinate system 60. In a similar implementation, the team coordinate system 60 and the field coordinate system 50 differ only by a scaling factor (that is, there is no concern for translational or rotational change of the stationary target with respect to the team coordinate system 60)—this may be useful where different sizes of sports field 47 are used for the same sport (a situation that occurs frequently in AFL).

A form of hysteresis may be applied to the zones to avoid determined player locations being changed between two zones while a player 48 is stationary but on the border between the zones. For example, a player may need to move into a further adjacent zone to cause a change.

Also, generally, structure models are configured to provide an area in which the player 48 can be located satisfying the intended location—for example, the player 48 may be considered correctly located when within a 5-metre radius of their calculated intended location.

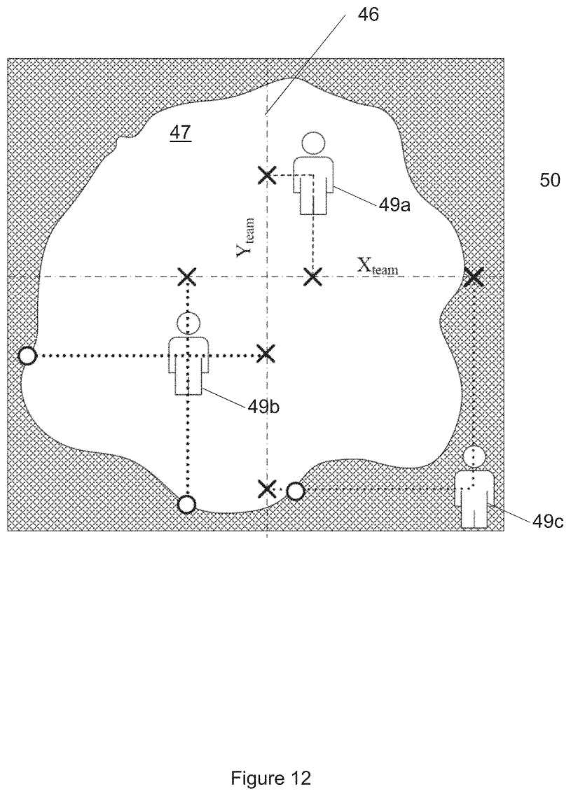

Referring to FIG. 12, account may be taken by the structure model for the boundary 46 of the bounded area 47 by correcting intended positions found outside (or near) the boundary 46. For example, where intended positions are calculated as being a relative location to a reference target 49 (or, of course, targets 49), it may be that the intended location is determined to be outside of the bounded area 47 (i.e. field of play). The figure shows the uncorrected calculated positions of players 48a, 48b, and 48c—as can be seen, the calculated intended location of player 48c is outside of the bounded area 47.

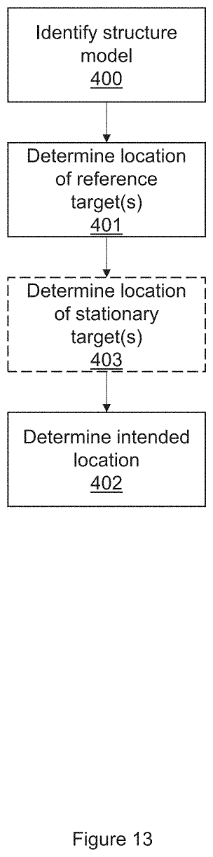

Referring to FIG. 13, the uncorrected determined intended position of a player 48 is transformed into the field coordinate system 50 from the team coordinate system 60, at step 500. The server 12 then identifies whether the uncorrected indented position is within a threshold distance of the boundary 46, at step 501. This generally will include any locations outside of the bounded area 47 and may include a distance inside the boundary 46. For example, the threshold distance may capture an uncorrected intended position outside of the boundary 46 or within 1-metre of the inside of the boundary 46. If the intended location is within the threshold distance, then the intended location is corrected to be a location not within the threshold distance, at step 502. In one implementation, the corrected intended location is the closest location to the uncorrected intended location that does not fall within the threshold distance. The threshold distance can, of course, be effectively zero (i.e. it corresponds to the boundary 46).

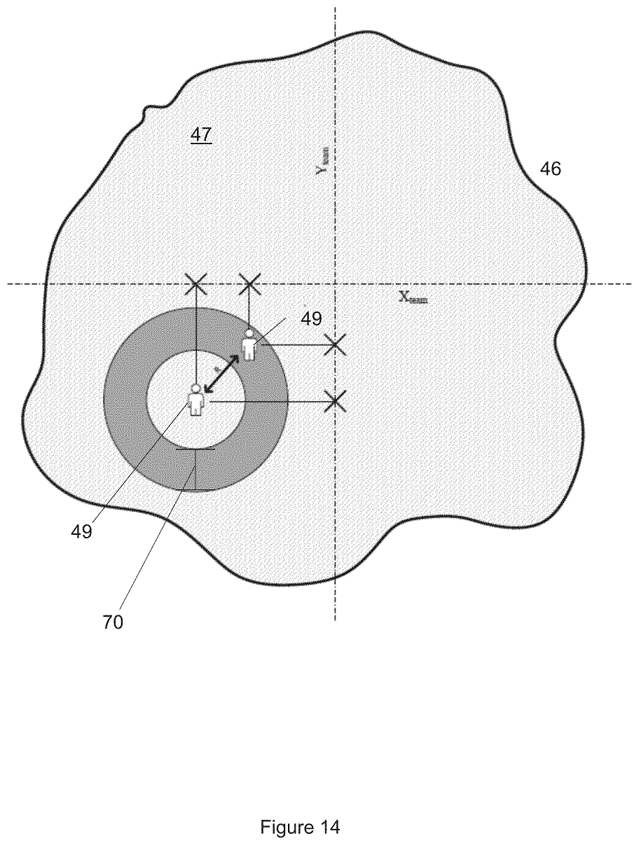

In another embodiment, with reference to FIG. 14, which may be considered a modification to the above embodiments or a separate embodiment, the relative positions of a plurality of players 48 to one another defines the structure model. In this case, the reference target 49 may be considered one of the players 48 or alternatively, another object such as a ball—then each other player 48 is provided with a distance from the reference target 49 but there is not defined an angle—i.e., it is not relevant as to the exact intended location, only that the player 48 is with a certain distance range 70. Thus, polar coordinates may be utilised with respect to the reference target.

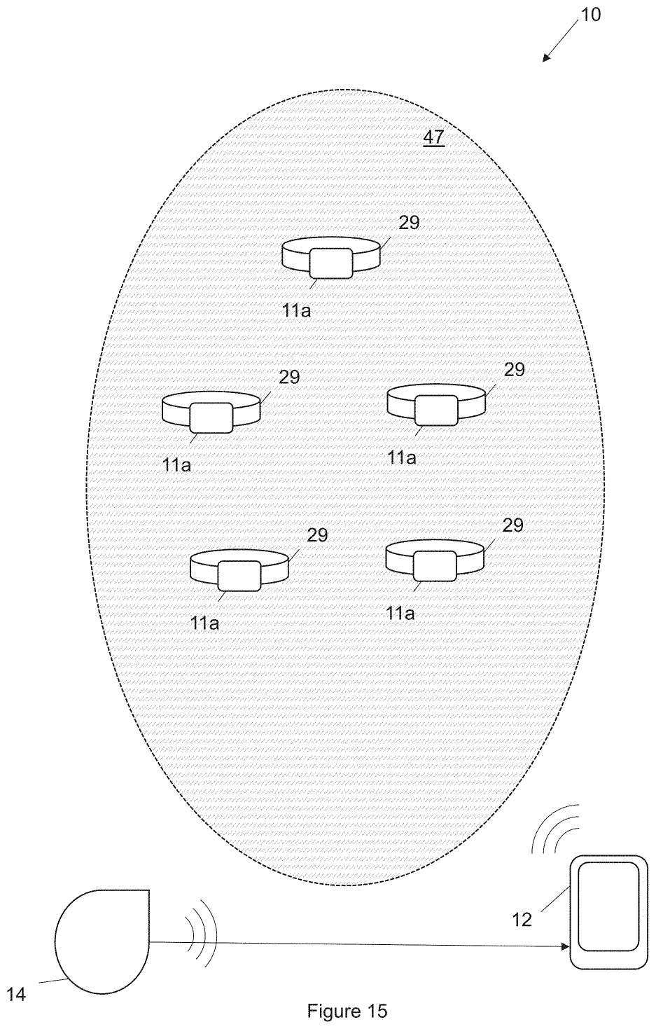

Referring to FIG. 15, the system of FIG. 1 is shown with an additional controller 14. The controller 14 is configured to enable to a user, such as a coach, to provide information to the server 12 regarding the current state of play. In particular, the controller 14 can signal when a particular gameplay event has occurred for which a particular structure model is appropriate (e.g. a throw-in in soccer). Thus, the controller 14 can be utilised to cause the server 12 to implement the methods herein described. For example, during training, players 49 may not be required to be in intended locations until the controller 14 is activated by the user. Therefore, the server 12 does not transmit instructions to the user devices 11 except when the controller 14 is activated. The controller 14 is typically in wireless communication with the server 12.

In an embodiment, each user device 11 is provided with a NFC transponder configured to transmit to a NFC reader a unique identity code associated with the user device 11. A NFC reader is also provided in communication with the server 12. A user device 11 can be activated for a particular training event by allowing its NFC transponder to be read by the NFC reader. Upon receiving, from the NFC reader, the unique identity code of the user device 11, the server 12 includes the user device 11 into the training event.

Further modifications can be made without departing from the spirit and scope of the specification. For example, the operation of the server 12 can be split across two or more computing devices. For example, a coach's device may be provided for implementing a front end to the server 12—in this case, the server 12 is wirelessly connected to the coach's device and configured to control a user interface of the coach's device and to receive data from the coach's device. Also, a base station may be provided for communicating with the user devices 11—in this case, the base station is in (usually wireless) communication with the server 12. In an embodiment, the base station or server 12 is configured for communicating GPS correction information to the user devices 11 to enable the locators 25 of these devices 11 to produce more accurate location determinations.

1.-56 (canceled)

57. A method for positional analysis, comprising:
receiving, from a user device, location information indicating a location of the user device;
identifying a location of at least one reference target;
determining at least one intended location of the user device by applying a structure model to the location of the, or each, reference target;
determining a difference between the, or each, intended location and the location of the user device;
determining a first result indicating whether the difference meets a threshold distance of a predefined threshold rule;
determining a second result indicating whether the predefined threshold rule is satisfied based at least in part on the first result; and
in response, communicating an instruction to the user device indicating that the predefined threshold rule is satisfied.

58. The method of claim 57, comprising:
determining that the intended location is outside of a boundary; and
applying a correction to the intended location, wherein the corrected intended location is within the boundary or the corrected intended location is not within a threshold distance of the boundary.

59. The method of claim 57, wherein the intended location is determined according to a team coordinate system and comprising the step of transforming the intended location to a field coordinate system in order to compare the intended location to the location of the user device.

60. The method of claim 59, wherein the team coordinate system is:
moveable with respect to one axis of the field coordinate system with fixed orientation;
moveable with respect to two axes of the field coordinate system with fixed orientation; or
moveable with respect to two axes of the field coordinate system with variable orientation.

61. The method of claim 59, wherein the team coordinate system is moveable with respect to two axes of the field coordinate system with variable orientation, the method comprising:
calculating a transformation between the team coordinate system and the field coordinate system based on, at least in part, a current position of at least one reference target with respect to at least one stationary target and/or at least one other user device in the field coordinate system.

62. The method of claim 61, wherein the transformation includes a scaling factor determined in accordance with the current position of the at least one reference target with respect to the at least one stationary target and/or the at least one other user device in the field coordinate system.

63. The method of claim 57, wherein the method is implemented by a server, wherein the server communicates with the user device via a base station, the method comprising:
receiving, at the server, a user input corresponding to a selection of the structure model for determining the intended location.

64. The method of claim 57, wherein a reference target is a movable target comprising a beacon device configured to emit a beacon signal, the method comprising:
receiving a signal strength measurement from each of one or more user devices, wherein the signal strength measurement is a measurement based on a received beacon signal received by the user device(s);
associating one of the user devices with the reference target based on the signal strength measurements; and
determining the reference target location to be the current location of the associated user device.

65. The method of claim 57, wherein the threshold rule corresponds to either: the difference being within a predefined value; or the difference being outside of a predefined value.

66. The method of claim 57, wherein the user device is configured to vibrate and/or emit an audible signal in response to receiving the instruction.

67. The method of claim 57, comprising:
defining the location of a boundary by recording the location of a user device as it is moved around the boundary.

68. The method of claim 57, wherein the structure model is configured to calculate the intended location relative to the location of at least one reference target.

69. The method of claim 57, comprising:
determining a player proximity rule defining an intended number of user devices for the intended location;
upon determining the first result indicating the user device is at one of a plurality of intended locations, determining a number of other user devices at the one determined intended location; and
determining a third result indicating that the player proximity rule is satisfied according to the number of other user devices at the intended location.

70. A method for positional analysis, comprising:
receiving, from a plurality of user devices, location information indicating a location of each user device;
identifying a location of at least one reference target;
determining at least one intended location of each user device by applying a structure model to the location of the, or each, reference target;
for each user device, determining a difference between the, or each, intended location and the location of the user device;
for each user device, determining a result indicating whether the difference meets a threshold distance of a predefined threshold rule;
for each user device, determining a second result indicating whether the predefined threshold rule is satisfied based at least in part on the first result; and
for each user device meeting the threshold rule, communicating an instruction to the user device indicating that the predefined threshold rule is satisfied.

71. A system for positional analysis, comprising:
one or more user devices, each comprising a stimulus module configured to, when activated, provide a recognizable stimulus to a wearer of the user device; and
a server,
wherein the one or more user devices are each configured for two-way communication with the server,
wherein the server is configured to:
receive location information indicating a location of a particular user device;
identify a location of at least one reference target;
determine at least one intended location of the particular user device by applying a structure model to the location of the, or each, reference target;
determine a difference between the, or each, intended location and the location of the particular user device;
determine a first result indicating whether the difference meets a threshold distance of a predefined threshold rule;
determine a second result indicating whether the predefined threshold rule is satisfied based at least in part on the first result; and
in response, communicating an instruction to the particular user device indicating that the predefined threshold rule is satisfied, and
wherein the, or each, user device is configured to:
determine a current location of the user device;
communicate location information indicating its location to the server;
in response to receiving an instruction to activate a stimulus from the server, activate the stimulus module.

72. The system of claim 71, wherein the server is configured to:
determine that the intended location is outside of a boundary; and
apply a correction to the intended location, wherein the corrected intended location is within the boundary or the corrected intended location is not within a threshold distance of the boundary.

73. The system of claim 71, wherein the intended location is determined according to a team coordinate system and wherein the server is configured to: transform the intended location to a field coordinate system in order to compare the intended location to the location of the user device.

74. The system of claim 73, wherein the team coordinate system is:
moveable with respect to one axis of the field coordinate system with fixed orientation;
moveable with respect to two axes of the field coordinate system with fixed orientation; or
moveable with respect to two axes of the field coordinate system with variable orientation.

75. The system of claim 73, wherein the team coordinate system is moveable with respect to two axes of the field coordinate system with variable orientation, and wherein the server is configured to: calculate a transformation between the team coordinate system and the field coordinate system based on, at least in part, a current position of at least one reference target with respect to at least one stationary target and/or at least one other user device in the field coordinate system.

76. The system of claim 75, wherein the transformation includes a scaling factor determined by the server in accordance with the current position of the at least one reference target with respect to the at least one stationary target and/or the at least one other user device in the field coordinate system.

77. The system of claim 71, comprising a base station, wherein the server communicates with the user devices via a base station, and wherein the server is configured to: receive a user input corresponding to a selection of the structure model for determining the intended location.

78. The system of claim 77, wherein the structure model is selected from a group of selectable structure models stored in a memory of the server and/or wherein the structure model is created by the user and then selected.

79. The system of claim 71, wherein a reference target is a movable target, the system comprising:
a locator device affixed to the movable target and configured to communicate location information indicating its position to the server, such that the server identifies the location of the movable target based on the received location information.

80. The system of claim 71, wherein a reference target is a moveable target, the system comprising:
a beacon device affixed to the movable target configured to intermittently or periodically emit a beacon signal,
and wherein each user device is configured to, upon detecting the beacon signal, determine a signal strength of the detected beacon signal and to communicate the signal strength to the server, and
wherein the server is configured to:
receive the signal strength measurement(s) from one or more of the user devices;
associate one of the user devices with the reference target based on the signal strength measurements; and
determine the reference target location to be the current location of the associated user device.

81. The system of claim 71, wherein the threshold rule corresponds to either: the difference being within a predefined value; or the difference being outside of a predefined value.

82. The system of claim 71, wherein one intended location is determined for each user device.

83. The system of claim 71, wherein the server is configured to:
determine a player proximity rule defining an intended number of user devices for the intended location;
upon determining the first result indicating the user device is at one of a plurality of intended locations, determine a number of other user devices at the one determined intended location; and
determine a third result indicating that the player proximity rule is satisfied according to the number of other user devices at the intended location.

84. A system for positional analysis, comprising:
one or more user devices, each comprising a stimulus module configured to, when activated, provide a recognizable stimulus to a wearer of the user device; and
a server,
wherein the one or more user devices are each configured for two-way communication with the server,
wherein the server is configured to:
receive location information indicating a location of at least one of the one or more user devices;
identify a location of at least one reference target;
determine at least one intended location of the at least one user device by applying a structure model to the location of the, or each, reference target;
determine a difference between the, or each, intended location and the location of the, or each of the at least one, user device;
determine a first result, for each of the at least one user device, indicating whether the difference meets a threshold distance of a predefined threshold rule;
determine a second result indicating whether the predefined threshold rule is satisfied based at least in part on the first result; and
in response, for each instance of the predefined threshold rule being satisfied, communicate an instruction to the associated user device indicating that the difference meets the predefined threshold rule, and
wherein the, or each, user device is configured to:
determine a current location of the user device;
communicate location information indicating its location to the server;
in response to receiving an instruction from the server, activate its stimulus module.
